(19) United States
(12) Patent Application Publication
(10) Pub. No.: US 2013/0191868 A1
(43) Pub. Date: Jul. 25, 2013

(54) Method for Displaying Information Associated with Television Program, Electronic Program Guide, and Processing Apparatus

(71) Applicants: Chao Liu, Qingdao City (CN); Mingang Wang, Qingdao City (CN); Fen Liu, Qingdao City (CN); Guangfeng Zhang, Qingdao City (CN); Tao Gao, Qingdao City (CN)

(72) Inventors: Chao Liu, Qingdao City (CN); Mingang Wang, Qingdao City (CN); Fen Liu, Qingdao City (CN); Guangfeng Zhang, Qingdao City (CN); Tao Gao, Qingdao City (CN)

(73) Assignee: Qing Dao Haie Electronic Co., Ltd., Qingdao City (CN)

(21) Appl. No.: 13/877,335

(22) PCT Filed: Dec. 3, 2010
(86) PCT No.: PCT/CN10/79439

§ 371 Date: Apr. 2, 2013

(51) Int. Cl. H04N 21/482

(52) U.S. Cl. CPC H04N 21/482
USPC 725/40

(57) ABSTRACT

The present invention relates to a method for displaying information associated with television program, which includes: acquiring at least one sequentially arranged program listings and corresponding program notes; generating an electronic program guide according to the program listings and corresponding program notes; and displaying the electronic program guide on a display screen. The electronic program guide includes a background area, at least one program listing, and a program note corresponding to one of the program listing. The background area is opaque and covers most of the display area. The present invention further provides an electronic program guide and a processing apparatus for generating the electronic program guide. The electronic program guide doesn't completely affect the normal television viewing.

### FIELD OF THE INVENTION

The present invention relates generally to digital television technology, and more particularly to a method for displaying information associated with television programs, an electronic program guide generated by the method, and a processing apparatus for generating the electronic program guide.

### BACKGROUND OF THE INVENTION

Digital television technology is the transmission of audio and video by digitally processed and multiplexed signal. In contrast to the conventional analog television transmitted via cables, digital television has advantages such as low signal loss, better image and voice quality, and thus is preferred by users. Furthermore, except the television signal, digital television is capable of transmitting additional information such as television program list for each channel, real time weather forecast, and even the digital television network can be used to surf internet. To ensure that the users can use the various functions provided by digital television conveniently, it is crucial to provide a user-friendly and intuitive user interface. Thus, in the known digital television system, electronic program guide is provided for the users to use the various functions provided by digital television systems.

For example, in a program list of a channel, the known manner is listing the programs within a certain time period in the time order; however, this manner not only cannot allow the user to focus on selected programs but also takes up a lot of screen space.

### SUMMARY OF THE INVENTION

To solve the aforementioned problem, an aspect of the present disclosure is to provide a method for displaying information associated with television programs in the case that doesn't completely affect the normal television viewing.

Another aspect of the present disclosure is to provide an electronic program guide that does not completely affect the normal television viewing.

Still another aspect of the present disclosure is to provide a processing apparatus for generating an electronic program guide for displaying information associated with television programs that doesn't completely affect the normal television viewing.

The above aspects of the present disclosure are achieved by the following technical solutions:

One embodiment of the present disclosure provides a method for displaying information associated with television programs, which includes: acquiring at least one sequentially arranged program listings and corresponding program notes; generating an electronic program guide according to the program listings and corresponding program notes; and displaying the electronic program guide on a display screen. The electronic program guide includes a background area, at least one program listing, and a program note corresponding to one of the program listing. The display screen defines a display area. The background area is opaque and covers most of the display area.

In another embodiment of the present disclosure, the above method further includes: highlighting currently selected one of the at least one program listings on the display screen, displaying a program note corresponding to the highlighted program listing on the display screen, and changing the program note according to the variation of the highlighted program listing.

In another embodiment of the present disclosure, the highlighting includes: displaying a border around the selected program listing or displaying a background under the selected program listing.

In another embodiment of the present disclosure, the program listing includes the broadcast time and a title.

In another embodiment of the present disclosure, the at least one program listing and the corresponding program notes are obtained from the received stream of digital television systems.

In another embodiment of the present disclosure, the method further includes: obtaining a channel list, wherein the at least one program listing and the corresponding program notes corresponds to a currently selected channel of the channel list; and making the at least one program listing and the corresponding program notes correspond to the previous channel or the next channel with respect to currently selected channel of the channel list according to a control instruction.

In another embodiment of the present disclosure, the electronic program guide includes a background area, and the background area is completely opaque.

Another embodiment of the present disclosure provides an electronic program guide for being displayed on a display screen. The display screen defines a display area. The electronic program guide includes a background area, at least one program listing, and a program note corresponding to one of the program listing. The background area is opaque and covers most of the display area.

In another embodiment of the present disclosure, a selected one of the at least one program listing is highlighted.

In another embodiment of the present disclosure, the selected one of the at least one program listing is highlighted by displaying a border around the selected program listing or displaying a background under the selected program listing.

Another embodiment of the present disclosure provides a processing apparatus for displaying an electronic program guide on a display screen. The processing apparatus includes: an information acquiring module, configured for acquiring at least one sequentially arranged program listings and corresponding program notes; an electronic program guide generating module, configured for generating an electronic program guide according to the program listings and corresponding program notes; and a displaying module, configured for displaying the electronic program guide on the display screen. The electronic program guide includes a background area, at least one program listing, and a program note corresponding to one of the program listing. The background area is opaque and covers most of a display area.

In another embodiment of the present disclosure, the processing apparatus further includes a program selecting module, configured for highlighting one of the at least one program listing in the electronic program guide and changing the program note in the electronic program guide according to the variation of highlighted program listing.

In the above described method for displaying information associated with television programs and the electronic program guide, because the background area of the electronic program guide only covers a part of the display area of the display screen; and thus a left part of the display area of the display screen that is not covered can be used to display the currently playing program or a program switched using the electronic program guide while the electronic program guide is displayed simultaneously. The method and the electronic program guide have the advantages of intuitive, simple, and straightforward.

To make above and other objects, features, and advantages be more apparent, the present disclosure is described in detail with preferred embodiments and the accompanying drawings as follows.

### BRIEF DESCRIPTION OF THE DRAWINGS

FIG. 1 is a block diagram of a digital television playing system provided by an embodiment of the present disclosure.

FIG. 2 is a flow chart of a method for displaying information associated with television programs according to an embodiment of the present disclosure.

FIG. 3 is a schematic view showing an architectural rendering of an electronic program guide is displayed on a display screen according to an embodiment of the present disclosure.

### DETAILED DESCRIPTION OF PREFERRED EMBODIMENTS

To further elaborate the technical means employed by the present invention to achieve the above objectives and the advantages, a method for displaying information associated with television program, an electronic program guide, and a processing apparatus provided by the present disclosure is described in detail with preferred embodiments and the accompanying drawings as follows.

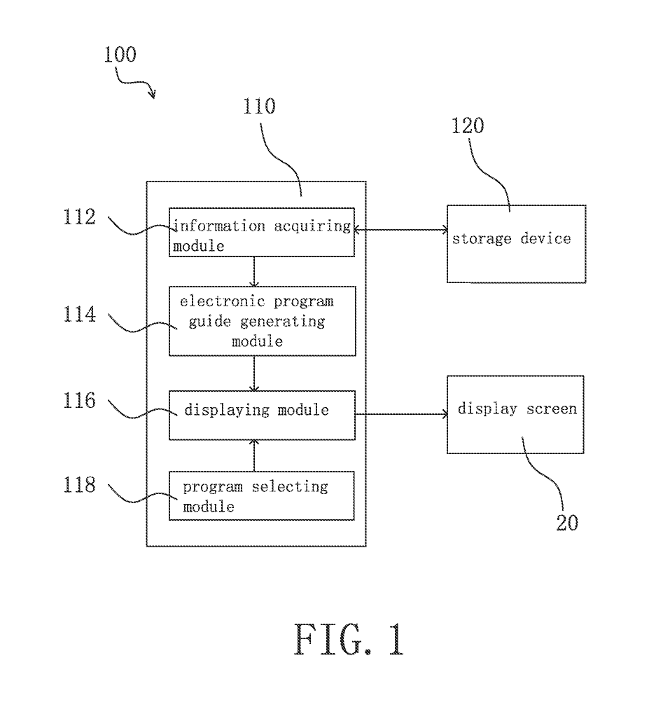

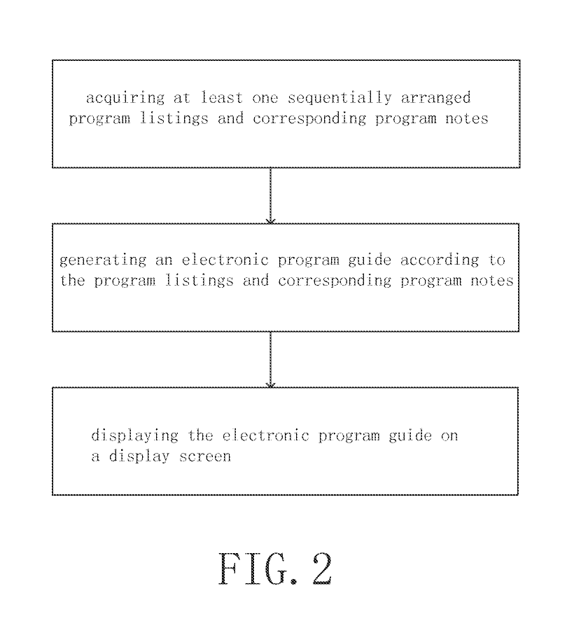

FIG. 1 is a block diagram of a digital television playing system provided by an embodiment of the present disclosure. A digital television playing system 100 includes a processing apparatus 110, a storage device 120 and a display screen 20. The display screen 20, for example, is a display screen of a digital television set (DTV). The processing apparatus 110 may include a microprocessor, for example, an embedded microprocessor of the digital television set. The storage device 120, for example, is a random access memory (RAM), a hard disk drive, or a solid state disk. In the present embodiment, the storage device 120 is a random access memory. The storage device 120 is configured for storing a plurality of program listings and program notes corresponding to the program listings that are arranged in a certain order, for example in the order of the broadcast time. The processing apparatus 110 is configured for generating an electronic program guide according to the program listings and the program notes stored in the storage device 120, and displaying the program listings and the program notes of the electronic program guide on the display screen 20. Specifically, the processing apparatus 110 includes an information acquiring module 112, an electronic program guide generating module 114, a displaying module 116, and a program selecting module 118.

FIG. 2 is a flow chart of a method for displaying information associated with television programs according to the present embodiment. The method is described with the processing apparatus 110 as follows. First, the information acquiring module 112 acquires the program listings and the program notes corresponding to the program listings, and stores them in the storage device 120. Next, the electronic program guide generating module 114 generates an electronic program guide according to the program listings and the corresponding program notes stored in the storage device 120. Last, the displaying module 116 controls the display screen 20 to display the electronic program guide.

When the information acquiring module 112 acquires the program listings and the program notes corresponding to the program listings, firstly, the currently selected or playing channel is obtained, then, program transport stream (TS) is locked according to the corresponding channel information. Program schedule and the corresponding introduction information could be read from the TS, and then converted into aforementioned program listings and the program notes in an appropriate format. The obtained program listings and the program notes are stored in the storage device 120. However, it is to be noted that, it is not limited to only use the above manner to obtain the program listings. For example, data (that describes the program listings) stored in an external storage device could be directly read, or downloaded via a network such as the internet. As it can provide accurate program listings, any methods could be applied into the present embodiment.

The program listings and the associated program notes are arranged in a certain order, for example, the time order. However, which order is used to store the program listings in the storage device 120 is not limited to be same with the certain order.

In another embodiment, the above method further includes: obtaining a channel list, wherein the at least one program listing and the corresponding program notes corresponds to a currently selected channel of the channel list; and making the at least one program listing and the corresponding program notes correspond to the previous channel or the next channel with respect to currently selected channel of the channel list according to a control instruction.

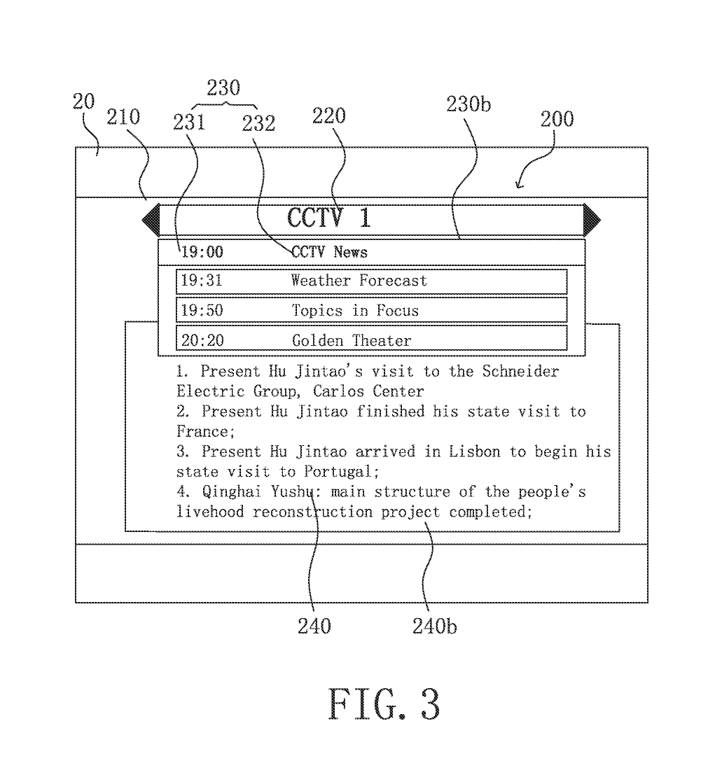

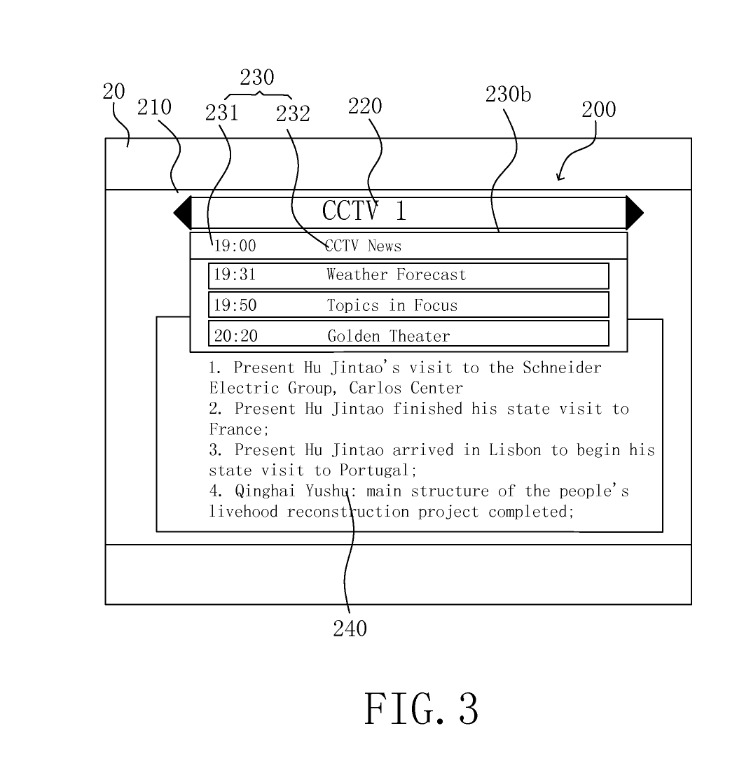

Please further refer to FIG. 3; it is a schematic view showing an architectural rendering of an electronic program guide 200 displayed on the display screen 20. The electronic program guide 200 includes a background area 210, a channel title 220, at least one sequentially arranged program listing 230, and a program note 240. The channel title 220, the program listing 230 and the program note 240 are in the background area 210, and are arranged from the top to the bottom of the background area 210 in the written order. The background area 210 may be translucent or completely opaque, and only covers most of the display screen 20. For example, the background area 210 may occupy more than 50% of the display area of the display screen. In the present embodiment, blank areas are preserved above and below the background area 210, respectively, and of course the blank areas can also be at the left, right or around the background area 210. The blank areas can be used to display the currently playing program of the playing channel while the electronic program guide is displayed simultaneously.

The channel title 220 can be highlighted by rendering it with different colors, increasing the font size or bolding it. In the present embodiment, the electronic program guide includes a plurality of program listings 230. Each program listing 230 may include a broadcast time 231 and a program title 232. In the present embodiment, the program listing 230 only include the broadcast time 231 and the program title 232. The program note 240 may include the following information of the program corresponding to the currently selected program listing 230: the content introduction, the background of the program, the text of the program broadcast or the conversation, the interpretation of related terms in the program, the related photos, the display screenshots or the video clip of the programs etc. According to the actual circumstance, the program note 240 may include a combination of the listed examples of the information. Under a default circumstance, the program listing 230 is corresponding to the program played in the currently playing channel or the lastly watched channel before using the electronic program guide.

In addition, to let the user clearly know that the currently viewed information is corresponding to which television program, one of the program listings 230 in the electronic program guide 200 could be highlighted. In other words, the processing apparatus 110 highlights one of the program listings 230 in the electronic program guide 200. The manners of highlighting may include: displaying an outer border around the program listing 230, displaying a colored background under the program listing 230, changing the font, the font size of the program listing 230, or a combination thereof. The content of the program note 240 corresponds to the marked or selected program listing 230. In the present embodiment, when the program selecting module 118 receives an instruction for selecting the program listing 230, for example, when the user press an “up” or “down” key, the program selecting module 118 highlights one of the program listings 230 and changes the program note 240 such that the content of the program note 240 is corresponding to the highlighted program listing 230, and the displaying module 116 displays the updated electronic program guide on the display screen 20.

Except highlighting the selected program listing 230 and changing the content of the corresponding program note 240, the processing apparatus 110 can further receives the users' instruction and then turn to the next program listing 230 and the program note 240. Because the display space is limited, the program listing 230 in all time periods can't all be listed in the display area of the display screen. In this case, the plurality of program listing 230 can be divided into several groups, and each group includes at least one program listing. When receives the users' instruction, the processing apparatus 110 can load the program listing in the group that is to be displayed. Similar to turning the program listing 230, the processing apparatus 240 can also turn the content of the program note 240 to the next one.

In aforementioned method for displaying information associated with television program and the electronic program guide, because the background area of the electronic program guide only covers a part of the display area of the display screen; and thus a left part of the display area of the display screen that is not covered can be used to display the currently playing program or a program switched using the electronic program guide while the electronic program guide is displayed simultaneously. The method and the electronic program guide have the advantages of intuitive, simple, and straightforward.

In above embodiments, the background area 210 of the electronic program guide 200 is translucent, or completely opaque. In addition, the background area 210 can also be completely transparent, or in other words, there isn't the background area 210. In this case, the channel title 220, the program listing 230 and the program note are directly displayed on the currently played television program. To obtain a clear displaying, bright colors can be used. In addition, the colors of different portions of the channel title 220, the program listing 230 and the program note 240 can be varied in real time according to the currently played television program such that it is easily to recognize them from the background, or in other words, the currently played television program.

The above descriptions are only preferred embodiments of the present disclosure, and are not intended to by any limit to the present invention. Any one of ordinarily skilled in the art would made minor variations or modifications to the above described embodiments within the spirit of the present disclosure, and the obtained technical means are also included in the scope of the present invention.

What is claimed is:

1. A method for displaying information associated with television programs, comprising:
acquiring at least one sequentially arranged program listing and corresponding program notes;
generating an electronic program guide according to said at least one program listings and corresponding program notes; and
displaying the electronic program guide on a display screen, the display screen defining a display area, wherein the electronic program guide comprises a background area, said at least one program listing, and a program note corresponding to one of said at least one program listing, and the background area is opaque and covers most of the display area.

2. The method for displaying information associated with television programs as claimed in claim 1, wherein the method further comprises:
highlighting currently selected one of said at least one program listings on the display screen; and
displaying a program note corresponding to the highlighted program listing on the display screen, and changing the program note according to the variation of the highlighted program listing.

3. The method for displaying information associated with television programs as claimed in claim 2, wherein said highlighting comprises:
displaying a border around the selected program listing or displaying a background under the selected program listing.

4. The method for displaying information associated with television programs as claimed in claim 1, wherein the program listing comprises the broadcast time and a title.

5. The method for displaying information associated with television programs as claimed in claim 1, wherein said at least one program listing and the corresponding program notes are obtained from the received stream of digital television systems.

6. The method for displaying information associated with television programs as claimed in claim 1, wherein the method further comprises:
obtaining a channel list, wherein said at least one program listing and the corresponding program notes corresponds to a currently selected channel of the channel list; and
making the at least one program listing and the corresponding program notes correspond to the previous channel or the next channel with respect to currently selected channel of the channel list according to a control instruction.

7. An electronic program guide, configured for being displayed on a display screen, the display screen defining a display area, the electronic program guide comprising:
a background area, at least one program listing, and a program note corresponding to one of the program listing, wherein the background area is opaque and covers most of the display area.

8. The electronic program guide as claimed in claim 7, wherein a selected one of the at least one program listing is highlighted.

9. The electronic program guide as claimed in claim 8, wherein the selected one of the at least one program listing is highlighted by displaying a border around the selected program listing or displaying a background under the selected program listing.

10. A processing apparatus, comprising:
an information acquiring module, configured for acquiring at least one sequentially arranged program listing and corresponding program notes;
an electronic program guide generating module, configured for generating an electronic program guide according to the program listings and corresponding program notes;
wherein the electronic program guide comprises a background area, at least one program listing, and a program note corresponding to one of the program listing, and the background area is opaque and covers most of a display area; and
a displaying module, configured for displaying the electronic program guide on a display screen.

11. The processing apparatus as claimed in claim 10, wherein the processing apparatus further comprises a program selecting module, configured for highlighting one of the at least one program listing in the electronic program guide and changing the program note in the electronic program guide according to the variation of highlighted program listing.
